(19) United States
(12) Patent Application Publication
(10) Pub. No.: US 2015/0381964 A1
(43) Pub. Date: Dec. 31, 2015

(54) Automatic Stereoscopic Camera Calibration

(71) Applicant: ST-ERICSSON SA, Plan-Les-Ouates (CH)

(72) Inventor: Antoine DROUOT, Paris (FR)

(21) Appl. No.: 14/767,608

(22) PCT Filed: Feb. 3, 2014
(86) PCT No.: PCT/EP2014/052071

§ 371 Date: Aug. 13, 2015

Related U.S. Application Data
(60) Provisional application No. 61/810,205, filed on Apr. 9, 2013.

(30) Foreign Application Priority Data
Mar. 14, 2013 (EP) 13305292.8

(51) Int. Cl. H04N 13/02; H04N 5/247

(52) U.S. Cl. CPC H04N 13/0246; H04N 13/0296; H04N 5/247

(57) ABSTRACT

An apparatus for calibrating a stereoscopic camera with respect to at least one stereo-image of the stereoscopic camera includes a processing unit configured to support at least a first triangulation unit, a second triangulation unit, and a Bundle Adjustment unit. The processing unit is configured to determine whether a convergence criterion has been met, the convergence criterion being indicative of whether or not a camera calibration ground-truth has been found.

### TECHNICAL FIELD

The present disclosure relates generally to stereoscopic cameras, and more specifically to a method and apparatus for calibrating such cameras.

### BACKGROUND ART

Stereoscopic vision has seen a surge of attention since the adoption of 3D technology for many applications (e.g. automotive driver assistance video games, sport performance analysis and surgery monitoring) and the arrival in the market of stereoscopic displays on smartphones, console games, PCs and TVs. Stereoscopic displays simultaneously show two views of the same scene at each moment in time and may require special 3D glasses to filter the corresponding view for the left and right eye of the viewer. Stereoscopic vision involves the use of two cameras which are separated by a given distance to record one or more images of the same scene, thereinafter referred to as stereo-images and wherein each stereo-image comprises a plurality of image-points.

Camera calibration is the operation of identifying the relationship between one or more image-points from stereo-images to corresponding real world 3D object-points coordinates defining an object in the real world. Then, once this relationship is established, 3D information can be inferred from 2D information, and, vice versa, 2D information can be inferred from 3D information. Camera calibration may also be need for image rectification which allows efficient depth estimation and/or comfortable stereo viewing.

Through camera calibration, it is identified for each camera, intrinsic parameters (such as, for example, focal length, scale factors, distortion coefficients, etc.) and extrinsic parameters (such as, for example, camera position and orientation with respect to the world coordinate system), or a subset of these under a given camera model such as the pinhole camera model. Determining intrinsic and extrinsic parameters may involve taking pictures in different angles of specially prepared objects with known dimensions and whose coordinates in the real world are precisely known as well, from e.g. prior measurements. For example, document (10) U.S. Pat. No. 7,023,473 B (SONY CORP) Apr. 4, 2006 discloses a calibration method which requires a calibration object with known features and several stereo-images of the know object shot under various angles.

However, this type of calibration technique requires precise initial calibration measurements and is not well suited for applications in uncontrolled environments where, for example, camera parameters may be subject to drift, due to shocks or vibrations, such as those experienced in a day to day basis by handled devices comprising a stereoscopic camera such as smartphone or tablets.

### SUMMARY OF INVENTION

Thus, an objective of the proposed solution is to overcome the above problem by performing an automatic calibration with at least one natural stereo-image without the need of special or known objects.

A first aspect of the proposed solution relates to an apparatus for calibrating a stereoscopic camera, the apparatus comprising:
a processing unit configured to support at least a first triangulation unit, a second triangulation unit and a Bundle Adjustment unit, with respect to at least one stereo-image of the stereoscopic camera, wherein:
the first triangulation unit and second triangulation unit are coupled to the Bundle Adjustment unit;
the first triangulation unit is configured to generate a first plurality of 3D object-point coordinates estimates (E3D) based on at least a plurality of measured 2D image-point correspondences (PCO) of the stereo-image and an initial calibration estimate (CAE) of the stereoscopic camera;
the first triangulation unit is further configured to generate a first reprojection error (RPE1) corresponding to the error between the PCO and a projection of the E3D on the CAE;
the Bundle Adjustment unit is configured to generate a refined calibration estimate (RCA) of the stereoscopic camera based on at least the PCO, the CAE and the E3D;
the second triangulation unit is configured to generate a second plurality of 3D object-point coordinates estimates (NE3D) based on at least the PCO and the RCA;
the second triangulation unit is further configured to generate a second reprojection error (RPE2) corresponding to the error between the PCO and a projection of the NE3D on the RCA;
the Bundle Adjustment unit is further configured to generate the refined calibration estimate (RCA) of the stereoscopic camera based on at least the PCO, the CAE and the NE3D; and,
the processing unit is further configured to determine a convergence criterion based on at least the RPE2 by iteratively generating the RCA and the RPE2, the convergence criterion being indicative of whether or not a camera calibration ground-truth has been found.

A second aspect relates to a device comprising:
a stereoscopic camera;
a stereoscopic image acquisition unit configured to acquire at least one stereo-image and coupled to the stereoscopic camera; and,
an apparatus as defined in the first aspect coupled to the stereoscopic image acquisition unit and configured to calibrate the stereoscopic camera based on the at least one stereo-image.

A third aspect relates to a device comprising:
a stereoscopic camera
a stereoscopic image acquisition unit configured to acquire at least one stereo-image and coupled to the stereoscopic camera;
a storage unit configured to store the at least one stereo-image and coupled to the stereoscopic image acquisition unit; and,
an apparatus as defined in the first aspect coupled to the storage unit and configured to calibrate the stereoscopic camera based on the at least one stereo-image.

A fourth aspect relates to a method of calibrating a stereoscopic camera, the method comprising, with respect to at least one stereo-image of the stereoscopic camera:
a first triangulation unit generating a first plurality of 3D object-point coordinates estimates (E3D) based on at least a plurality of measured 2D image-point correspondences (PCO) of the stereo-image and an initial calibration estimate (CAE) of the stereoscopic camera;
the first triangulation unit further generating a first reprojection error (RPE1) corresponding to the error between the PCO and a projection of the E3D on the CAE;
a Bundle Adjustment unit generating a refined calibration estimate (RCA) of the stereoscopic camera based on at least the PCO, the CAE and the E3D;
a second triangulation unit generating a second plurality of 3D object-point coordinates estimates (NE3D) based on at least the PCO and the RCA;
the second triangulation unit further generating a second reprojection error (RPE2) corresponding to the error between the PCO and a projection of the NE3D on the RCA;
the Bundle Adjustment unit further generating a refined calibration estimate (RCA) of the stereoscopic camera based on at least the PCO, the CAE and the NE3D; and, wherein a convergence criterion is determine based on at least RPE2 by iteratively generating the RCA and the RPE2, the convergence criterion being indicative of whether or not a camera calibration ground-truth has been found.

A fifth aspect relates to a computer program product stored in a non-transitory computer-readable storage medium that stores computer-executable code for calibrating a stereoscopic camera, the computer-executable process causing a processor of the computer to perform the method according to fourth aspect.

Thus in a device embodying the principles of such mechanism, it is it possible to perform camera calibration without the need of precise initial calibration measurements and also without the need of a controlled environment. This result is achieved by iterating the determination of camera calibration estimates until proposer solution is found.

The one with ordinary skills in the art should note also that the proposed solution may work with one stereo-image thus making it easy to implement and cost effective.

This is in contrast with prior art solutions wherein, for example, at least two different stereo-images may be needed as already explained above.

In an embodiment, the initial calibration estimate is a coarse estimate of the camera calibration ground-truth.

In one embodiment, the initial calibration estimate is derived from physical specifications of the stereoscopic camera.

In another embodiment, the convergence criterion is fulfilled when the following formula apply:

RPE2+ε>RPE1

where:
ε is a positive number.

In yet another embodiment, the convergence criterion is fulfilled when the following formula apply:

RPE2_{current}+ε>RPE2ₚᵣₑᵥᵢₒᵤₛ

where:
ε is a positive number;
RPE2_{current} is the RPE2 of the current iteration; and,
RPE2ₚᵣₑᵥᵢₒᵤₛ is the RPE2 of the iteration preceding the current iteration.

Possibly, the number ε is in the range of 1e⁻³ to 1e⁻¹.

In one embodiment, the convergence criterion is fulfilled after a given number of iterations have been performed.

Possibly, the convergence criterion is fulfilled when the following formula apply:

RPE2_{current}<RPE2ₜₕ

where:
RPE2_{current} is the RPE2 of the current iteration; and,
RPE2ₜₕ is a predetermined reprojection error.

### BRIEF DESCRIPTION OF DRAWINGS

A more complete understanding of the proposed solution may be obtained from a consideration of the following description in conjunction with the appended drawings, in which like reference numbers indicate the same or similar element and in which:

FIG. 1 is a block diagram illustrating a prior art apparatus for calibrating a camera.

FIG. 2 is a block diagram illustrating an embodiment of an apparatus for calibrating a camera according to the proposed solution.

FIG. 3 is a flow diagram illustrating an embodiment of a method of calibrating a camera used by the apparatus of FIG. 2.

FIG. 4 is a block diagram illustrating an embodiment of the apparatus of FIG. 2 in a device according to the proposed solution.

FIG. 5 is a block diagram illustrating another embodiment of the apparatus of FIG. 2 in a device according to the proposed solution.

### DESCRIPTION OF EMBODIMENTS

Referring now to FIG. 1, there is shown therein a block diagram schematically illustrating a prior art apparatus 100 for calibrating a camera. The prior art apparatus 100 as shown comprises a processing unit 101 such as a processor and adapted to support a triangulation (TRI) unit 110 and a Bundle Adjustment (BA) unit 120 that are coupled together. The prior art apparatus 100 may be coupled to a camera (not shown) such as a stereoscopic camera and may have access to a plurality of stereo-images (not shown) taken by the camera.

Referring to FIG. 1, the TRI unit 110 is configured to implement a triangulation technique and the BA unit 120 is configured to implement a Bundle Adjustment technique, both techniques being well known techniques in computer vision community so that no detailed description thereof will be provided here.

The TRI unit 110 may also be configured to determine a first estimate of 3D object-points coordinates (E3D) based on at least:
a plurality of measured 2D image-point correspondences (PCOₙ) with respect to the plurality of stereo-images; and,
an initial precise version of intrinsic and extrinsic parameters of the camera thereinafter referred to as initial precise calibration estimate (CAEₚ).

The PCOₙ may correspond to the projections of real world object-points on the left and right images of each of the plurality stereo-images. The PCOₙ may be obtained using correspondence search methods such as Area-based methods or feature-based methods such as feature matching, block matching or optical flow.

The CAEₚ may be obtained by accurate measurements performed on the camera. Measurements could have been performed with conventional calibration methods such as using calibration patterns, manual setup or offline computing means, for example.

Referring back to FIG. 1, the BA unit 120 may also be configured to determine a refined calibration estimate (RCA) of the camera based on at least the PCOₙ, the CAEₚ and the E3D. For example, methods such as Levenberg-Marquardt or gradient decent may be used for such purpose.

One drawback of the prior art apparatus 100 is the fact that the BA unit 120 performs well only with an estimate of the camera calibration which is hard to obtain since it needs to be very precise. In fact, the CAEₚ used in the BA unit 120 needs to be quite close to the camera calibration ground-truth, i.e. the real world camera features of the camera used to acquire the plurality of stereo-images.

Improvements over the prior art apparatus 100 may be found, for example, in document (20) DANG, Thao, et al. Continuous stereo self-calibration by camera parameter tracking. IEEE Transactions on Image Processing. July 2009, vol. 18, no. 7, p. 1536-1550, wherein the BA unit 120 is recursively applied on a plurality of stereo-images in order to further improve the refinement of an initial coarse calibration estimate (CAE_{c}) which is an initial guess of the calibration estimate and therefore less precise than the CAEₚ. Additionally, in document (20), a trifocal constraint also known as trilinear constraint is used on the PCOₙ, meaning that it is required that a correspondence search is performed on at least three images. Namely, a point of the E3D utilising the left and right images of a stereo-image should triangulate to the same point in the E3D when a third image is taken into consideration. One drawback of trifocal constraint is that it is complex to implement and requires a lot of processing time. Another drawback is the fact that it is required to acquire at least three images.

The above drawbacks may be overcome to some extent by embodiments of the proposed solution, by taking into account at least one stereo-image for improving the refinement of the CAE_{c}. According to the proposed solution, the at least one stereo-image may be a natural stereo-image wherein no special object with particular characteristics need to present therein.

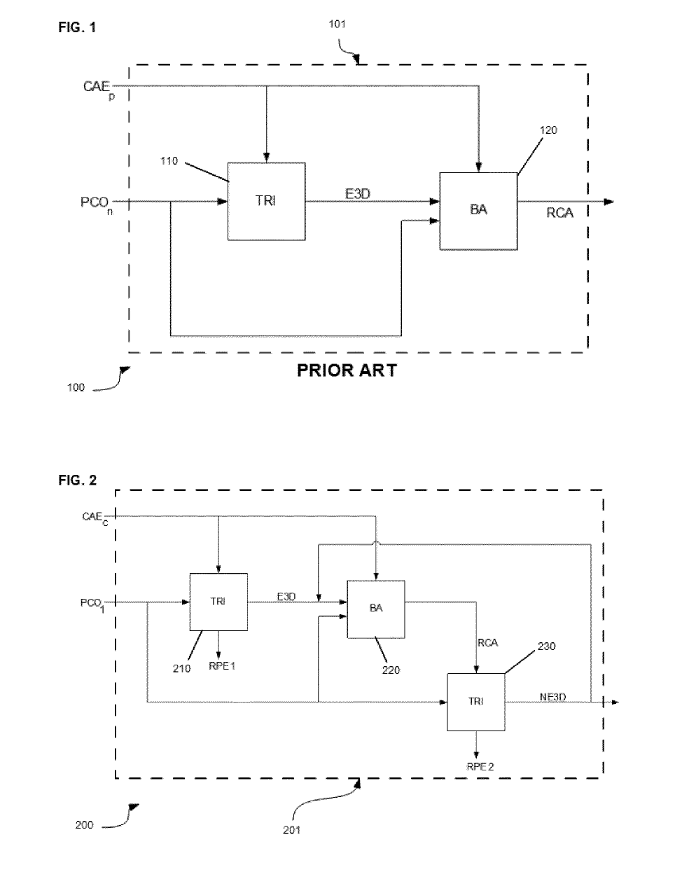

Referring now to FIG. 2, there is shown therein an embodiment of an apparatus 200 for calibrating a camera according to the proposed solution. The apparatus 200 as shown comprises a processing unit 201 such as a processor and adapted to support a first TRI unit 210, a BA unit 220 and a second triangulation unit (TRI) 230 wherein the first TRI unit 210 and the second TRI unit 230 are both coupled to the BA unit 210.

The apparatus 200 may be coupled to the camera (not shown) such as a stereoscopic camera and may have access to at least one stereo-image (not shown) taken by the camera.

Referring to FIG. 2, the first TRI unit 210 may be configured to determine a first estimate of 3D object-points coordinates (E3D) based on at least:
a plurality of measured 2D image-point correspondences (PCO₁) with respect to the at least one stereo-image; and,
an initial coarse version of intrinsic and extrinsic parameters of the camera thereinafter referred to as initial coarse calibration estimate (CAE_{c}).

The PCO₁ may correspond to the projections of real world object-points on the left and right images of the at least one stereo-image. The PCO₁ may be obtained using methods as described above regarding the PCOₙ.

The CAE_{c} may be a coarse estimate of the camera calibration ground-truth instead of being a precise estimate as it was necessary the case in the prior art regarding CAEₚ.

For example, the CAE_{c} may be deduced from the specifications of the camera.

For example, the principal point coordinates of the camera may be assumed to be in the middle of the sensor. Possibly, the skew factor may be assumed to be equal to 0 as it is the case for most of the modern sensors. Additionally, the parallel lens axis setup in which cameras of a stereoscopic camera are aligned on X and Y axis may be equal to a rigid transformation (R,t), where

$$t = ( - b , 0 , 0 ) and R = [ \begin{matrix}1 & 0 & 0 \\ 0 & 1 & 0 \\ 0 & 0 & 1\end{matrix} ]$$

is the 3×3 identity matrix and b is the distance between the two camera axis also referred to as the baseline.

Referring back to FIG. 2, the first TRI unit 210 may also be configured to determine a reprojection error (RPE1) corresponding to the error between the PCOM and a projection of the E3D on the CAE. For example, the RPE1 may be equal to the average Euclidian distance between the points in the PCOM and the projection of their corresponding triangulated points in the E3D on the CAE_{c}.

The BA unit 220 may also be configured to determine a refined calibration estimate (RCA) of the camera based on at least the PCO₁, the CAE_{c} and the E3D using, for example, methods as described above.

The second TRI unit 230 may be configured to determine a second estimate of 3D object-points coordinates (NE3D) based on at least the PCOM and the RCA using, for example triangulation techniques as described above.

The second TRI unit 230 may also be configured to determine a second reprojection error (RPE2) corresponding to the error between the PCOM and a projection of the NE3D on the RCA. For example, RPE2 may be equal to the average Euclidian distance between the points in the PCOM and the projection of their corresponding triangulated points in the NE3D on the RCA.

The BA unit 220 may also be configured to determine again the refined calibration estimate (RCA) of the camera based on at least the PCO₁, the CAE_{c} and the NE3D using, for example, methods as described above.

The one with ordinary skills in the art should note that using the RCA to triangulate the E3D based on the PCO₁, allows obtaining the NE3D which is a more accurate estimate of the real world 3D object-points coordinates than the E3D.

The proposed solution is based on the idea that by iterating the determination of the RPE2 and the RCA, it is possible for the iterated RCA to converge towards the camera calibration ground-truth. For example, the operations of the BA unit 220 and the operations of the second TRI unit 230 may be iterated to achieve such a goal wherein each iterations starts with different initial parameters that become more and more close to their true value. Another important idea of the proposed solution, is the fact the CAE_{c} is used in the determination of the current RCA instead of the RCA determined in the preceding iteration which is however available. In fact, it has been found that this choice would ensure that the iterated RCA would not converge to an odd camera calibration estimate that may be numerically sound but not physically relevant.

According to the proposed solution, the iteration process may be stopped based on a monitoring of the RPE2 for example at the output of the second TRI unit 230. Namely, as long as the RPE2 significantly decreases in consecutive iterations, then the process continues to be iterated. However, if the RPE2 suddenly increases, or simply does not decrease significantly, then the process is stopped.

Possibly, the iteration process may be stopped when a given convergence criterion is fulfilled.

In one embodiment, the convergence criterion may be fulfilled when the following formula apply:

RPE2+ε>RPE1 (3)

where:
ε is a positive variation number.

The above embodiment may be directed to the first iteration such that when the first RPE2 is available it can be compared to RPE1.

In another embodiment, the convergence criterion may be fulfilled when the following formula apply:

RPE2_{current}+ε>RPE2ₚᵣₑᵥᵢₒᵤₛ (4)

where:
ε is the positive variation number;
RPE2_{current} is the RPE2 of the current iteration; and,
RPE2ₚᵣₑᵥᵢₒᵤₛ is the RPE2 of the iteration preceding the current iteration.

The above embodiment may be directed to the subsequent iterations such that when the current RPE2 is available it can be compared to RPE2 determined in the iteration preceding the current iteration.

According to the proposed solution, the variation number ε may be in the range of range of 1e⁻³ to 1e⁻¹. However, other ranges may be possible depending on the required application or the required degree of accuracy.

Namely, the variation number ε indicates whether the variation of the current RPE2 compared to the RPE1 or the RPE2 of the iteration preceding the current iteration is small enough in order for the iteration process to be stopped, meaning that it is considered that no variation has occurred between two subsequent iterations. Therefore ε also indicates that when the variation is large the iteration should continue to the subsequent iteration.

In other words, the iteration process would stop when a small decrease of the current RPE2 compared to the RPE1 or the RPE2 of the iteration preceding the current iteration is observed.

Alternatively, the iteration process would also stop when an increase of the current RPE2 compared to the RPE1 or the RPE2 of the iteration preceding the current iteration is observed.

Another possibility may consist in stopping the iteration after a given number of iterations have been performed. In that case, for example, the convergence criterion may be fulfilled when the following formula apply:

RPE2_{current}<RPE2ₜₕ (5)

where:
RPE2_{current} is the RPE2 of the current iteration; and,
RPE2ₜₕ is a predetermined reprojection error.

In accordance with this embodiment the current RPE2 may be compared to a predetermined reprojection error RPE2ₜₕ corresponding to a desired reprojection error assessing the quality of the camera calibration process. For example, the predetermined reprojection error RPE2ₜₕ may have been obtained based on laboratory measurements or may be based on experience.

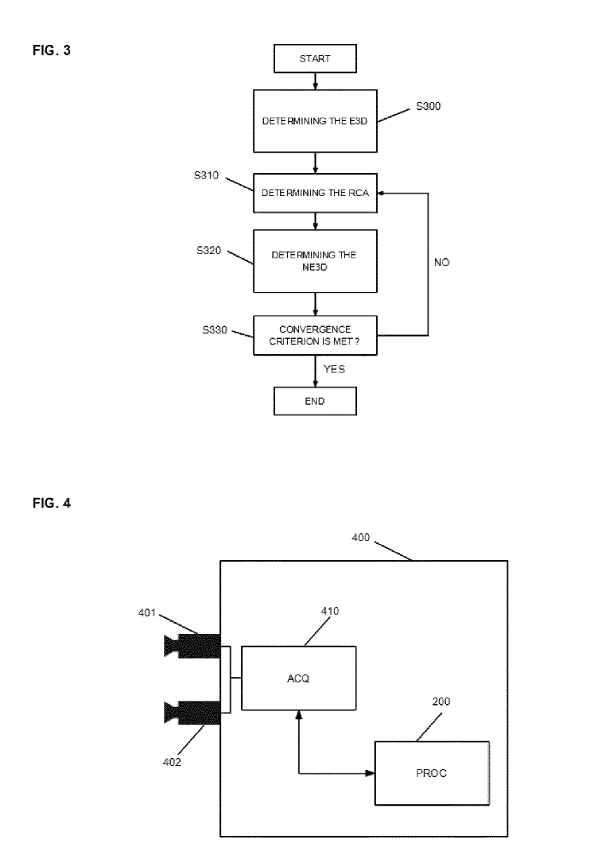

Thereinafter, reference will be made to FIG. 3, which is illustrating an embodiment of a method of calibrating a camera used by the apparatus 200 of FIG. 2.

In S300, it is determined the E3D with respect to at least one stereo-image, for example using the first TRI unit 210. As explained above, the RPE1 may also be determined at this stage.

In S310, it is determined the RCA with respect to the at least one stereo-image, for example using the BA unit 220.

In S320, it is determined the NE3D with respect to the at least one stereo-image, for example using the second TRI unit 230. As explained above, the RPE2 may also be determined at this stage.

In S330, it is determined whether the convergence criterion is fulfilled, for example by monitoring the RPE2. In the first iteration, the convergence criterion may be determined by using, for example, the formula (3). In the subsequent iterations, the convergence criterion may be determined by using, for example, the formula (4). However, as explained above, the method could also be stopped after a given number of iterations have been performed and/or when the convergence criterion based on the formula (5) is fulfilled.

Thus, until an acceptable RCA is found, the method would iterate through S310, S320 and S330.

The proposed solution may also be implemented in a computer program product stored in a non-transitory computer-readable storage medium that stores computer-executable code which causes a processor computer to perform a method according to the proposed solution. For example, the above program product may be embodied in a device comprising a stereoscopic camera and run during the manufacturing phase of the device such that the stereoscopic camera is calibrated as soon as a customer buys it. The program product may also be run directly by a user of the device, where for example in a GUI it would be asked to either take a stereo-image or select a previously recorded one and then a point correspondence search could be performed on the stereo-image prior the application of the method on the stereo-image. The point correspondence search could be automatically performed on each stereo-image taken or previously stored on the device. This operation that could be quite resource intensive could be performed as a background task or with a low priority such that it is not perceivable by the user, for example while the device is plugged on a charging socket. In one embodiment, the program product could be run when the device has detected that it has been subject to a mechanical shock such as a drop of the device on the floor.

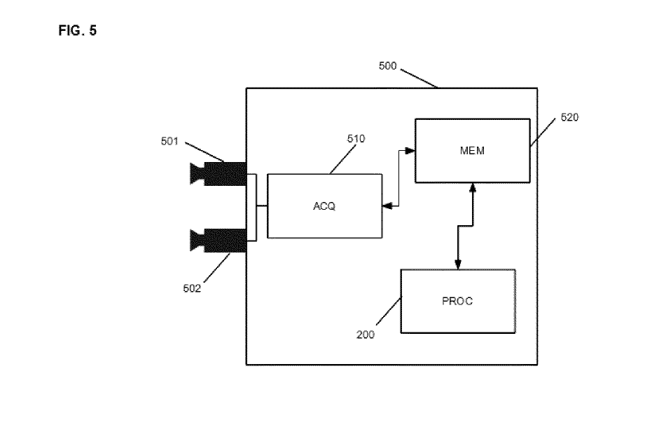

Referring now to FIG. 4, there is shown therein a block diagram schematically illustrating an embodiment of the apparatus 200 of FIG. 2 in a device 400 according to the proposed solution. The device 400 as shown comprises a stereoscopic camera 401, 402, a stereoscopic image acquisition unit 410 and the apparatus 200. The stereoscopic image acquisition unit 410 is coupled to the stereoscopic camera 401, 402 and is configured to acquire at least one stereo-image using the stereoscopic camera 401, 402. The stereoscopic image acquisition unit 410 is also coupled to the apparatus 200 and is also configured to provide the at least one stereo-image to the apparatus 200 wherein the apparatus 200 is configured to calibrate the stereoscopic camera 401, 402 based on the at least one stereo-image.

Referring now to FIG. 5, there is shown therein a block diagram schematically illustrating an embodiment of the apparatus 200 of FIG. 2 in a device 500 according to the proposed solution. The device 500 as shown comprises a stereoscopic camera 501, 502, a stereoscopic image acquisition unit 510, a storage unit 520 and the apparatus 200. The stereoscopic image acquisition unit 510 is coupled to the stereoscopic camera 501, 502 and is configured to acquire at least one stereo-image using the stereoscopic camera 501, 502. The stereoscopic image acquisition unit 510 is also coupled to the storage unit 520 and is also configured to provide the at least one stereo-image to the storage unit 520. The storage unit 520 is coupled to the apparatus 200 and is configured to store at least one stereo-image provided by the stereoscopic image acquisition unit 510. Additionally, the storage unit 520 is also configured to provide the at least one stereo-image to the apparatus 200 wherein the apparatus is configured to calibrate the stereoscopic camera based on the at least one stereo-image.

The device 400, 500 may be handheld devices, portable devices, wireless devices, non-wireless devices, smartphone or a tablets, for example.

Although the description has been presented mainly based on one stereo-image, a plurality of stereo-images or an entire video may be considered as well. The stereo-images may be natural images but non-natural images such as those comprising special objects to help calibration cameras may be considered as well. Additionally, for example, the triangulation units may be comprised in the same unit.

Of course, the above advantages are exemplary, and these or other advantages may be achieved by the proposed solution. Further, the skilled person will appreciate that not all advantages stated above are necessarily achieved by embodiments described herein.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to inventions containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

### REFERENCE LIST

Document (10): U.S. Pat. No. 7,023,473 B (SONY CORP) 04.04.2006.
Document (20): DANG, Thao, et al. Continuous stereo self-calibration by camera parameter tracking. IEEE Transactions on Image Processing. July 2009, vol. 18, no. 7, p. 1536-1550.

1. An apparatus for calibrating a stereoscopic camera, the apparatus comprising:
a processing unit configured to support at least a first triangulation unit, a second triangulation unit and a Bundle Adjustment unit, with respect to at least one stereo-image of the stereoscopic camera, wherein:
the first triangulation unit and second triangulation unit are coupled to the Bundle Adjustment unit;
the first triangulation unit is configured to generate a first plurality of 3D object-point coordinates estimates, E3D, based on at least a plurality of measured 2D image-point correspondences, PCO, of the stereo-image and an initial calibration estimate, CAE, of the stereoscopic camera;
the first triangulation unit is further configured to generate a first reprojection error, RPE1, corresponding to the error between the PCO and a projection of the E3D on the CAE;
the Bundle Adjustment unit is configured to generate a refined calibration estimate, RCA, of the stereoscopic camera based on at least the PCO, the CAE and the E3D;
the second triangulation unit is configured to generate a second plurality of 3D object-point coordinates estimates, NE3D, based on at least the PCO and the RCA;
the second triangulation unit is further configured to generate a second reprojection error, RPE2, corresponding to the error between the PCO and a projection of the NE3D on the RCA;
the Bundle Adjustment unit is further configured to update the RCA of the stereoscopic camera based on at least the PCO, the CAE and the NE3D; and,
the processing unit is further configured to determine whether a convergence criterion has been met, the convergence criterion being based on at least the RPE2 obtained by iteratively generating the RCA and the RPE2 and being indicative of whether or not a camera calibration ground-truth has been found.

2. The apparatus of claim 1, wherein the initial calibration estimate is a coarse estimate of the camera calibration ground-truth.

3. The apparatus of claim 2, wherein the initial calibration estimate is derived from physical specifications of the stereoscopic camera.

4. The apparatus of claim 1, wherein the convergence criterion is fulfilled if
RPE2+ε>RPE1
where ε is a positive number.

5. The apparatus of claim 1, wherein the convergence criterion is fulfilled if
RPE2_{current}+ε>RPE2ₚᵣₑᵥᵢₒᵤₛ
where ε is a positive number, RPE2_{current} is the RPE2 of the current iteration, and RPE2ₚᵣₑᵥᵢₒᵤₛ is the RPE2 of an iteration preceding a current iteration.

6. The apparatus of claim 1, wherein the convergence criterion is fulfilled after a given number of iterations have been performed.

7. The apparatus of claim 6, wherein the convergence criterion is fulfilled if
RPE2_{current}<RPE2ₜₕ
where RPE2_{current} is the RPE2 of the current iteration, and, RPE2ₜₕ is a predetermined reprojection error.

8. A device comprising:
a stereoscopic camera;
a stereoscopic image acquisition unit configured to acquire at least one stereo-image and coupled to the stereoscopic camera; and,
an apparatus coupled to the stereoscopic image acquisition unit and configured to calibrate the stereoscopic camera based on the at least one stereo-image, the apparatus including a processing unit configured to support at least a first triangulation unit, a second triangulation unit and a Bundle Adjustment unit, with respect to at least one stereo-image of the stereoscopic camera, wherein:
the first triangulation unit and second triangulation unit are coupled to the Bundle Adjustment unit;
the first triangulation unit is configured to generate a first plurality of 3D object-point coordinates estimates, E3D, based on at least a plurality of measured 2D image-point correspondences, PCO, of the stereo-image and an initial calibration estimate, CAE, of the stereoscopic camera;
the first triangulation unit is further configured to generate a first reprojection error, RPE1, corresponding to the error between the PCO and a projection of the E3D on the CAE;
the Bundle Adjustment unit is configured to generate a refined calibration estimate, RCA, of the stereoscopic camera based on at least the PCO, the CAE and the E3D;
the second triangulation unit is configured to generate a second plurality of 3D object-point coordinates estimates, NE3D, based on at least the PCO and the RCA;
the second triangulation unit is further configured to generate a second reprojection error, RPE2, corresponding to the error between the PCO and a projection of the NE3D on the RCA;
the Bundle Adjustment unit is further configured to update the RCA of the stereoscopic camera based on at least the PCO, the CAE and the NE3D; and,
the processing unit is further configured to determine whether a convergence criterion has been met, the convergence criterion being based on at least the RPE2 obtained by iteratively generating the RCA and the RPE2 and being indicative of whether or not a camera calibration ground-truth has been found.

9. A device comprising:
a stereoscopic camera;
a stereoscopic image acquisition unit configured to acquire at least one stereo-image and coupled to the stereoscopic camera;
a storage unit configured to store the at least one stereo-image and coupled to the stereoscopic image acquisition unit; and,
an apparatus coupled to the storage unit and configured to calibrate the stereoscopic camera based on the at least one stereo-image, the apparatus including a processing unit configured to support at least a first triangulation unit, a second triangulation unit and a Bundle Adjustment unit, with respect to at least one stereo-image of the stereoscopic camera, wherein:
the first triangulation unit and second triangulation unit are coupled to the Bundle Adjustment unit;
the first triangulation unit is configured to generate a first plurality of 3D object-point coordinates estimates, E3D, based on at least a plurality of measured 2D image-point correspondences, PCO, of the stereo-image and an initial calibration estimate, CAE, of the stereoscopic camera;
the first triangulation unit is further configured to generate a first reprojection error, RPE1, corresponding to the error between the PCO and a prosection of the E3D on the CAE;
the Bundle Adjustment unit is configured to generate a refined calibration estimate, RCA, of the stereoscopic camera based on at least the PCO, the CAE and the E3D;
the second triangulation unit is configured to generate a second plurality of 3D object-point coordinates estimates, NE3D, based on at least the PCO and the RCA;
the second triangulation unit is further configured to generate a second reprojection error, RPE2, corresponding to the error between the PCO and a projection of the NE3D on the RCA;
the Bundle Adjustment unit is further configured to update the RCA of the stereoscopic camera based on at least the PCO, the CAE and the NE3D; and,
the processing unit is further configured to determine whether a convergence criterion has been met, the convergence criterion being based on at least the RPE2 obtained by iteratively generating the RCA and the RPE2 and being indicative of whether or not a camera calibration ground-truth has been found.

10. A method of calibrating a stereoscopic camera with respect to at least one stereo-image of the stereoscopic camera, the method comprising:
generating a first plurality of 3D object-point coordinates estimates, E3D, based on at least a plurality of measured 2D image-point correspondences, PCO, of the stereo-image and an initial calibration estimate, CAE, of the stereoscopic camera;
generating a first reprojection error, RPE1, corresponding to the error between the PCO and a projection of the E3D on the CAE;
generating a refined calibration estimate, RCA, of the stereoscopic camera based on at least the PCO, the CAE and the E3D;
generating a second plurality of 3D object-point coordinates estimates, NE3D, based on at least the PCO and the RCA
generating a second reprojection error, RPE2, corresponding to the error between the PCO and a projection of the NE3D on the RCA; and
updating the RCA; of the stereoscopic camera based on at least the PCO, the CAE and the NE3D, wherein a convergence criterion is determine based on at least RPE2 by iteratively generating the RCA and the RPE2, the value of RPE2 being indicative of whether or not a camera calibration ground-truth has been found.

11. The method of claim 10, wherein the initial calibration estimate is a coarse estimate of the camera calibration ground-truth.

12. The method of claim 10, wherein the convergence criterion is fulfilled if
RPE2+ε>RPE1
where is a positive number.

13. The method of claim 10, wherein the convergence criterion is fulfilled if
RPE2_{current}+ε>RPE2ₚᵣₑᵥᵢₒᵤₛ
where is a positive number, RPE2_{current} is the RPE2 of the current iteration; and, RPE2ₚᵣₑᵥᵢₒᵤₛ is the RPE2 of the iteration preceding the current iteration.

14. The method of claim 10, wherein the convergence criterion is fulfilled after a given number of iterations have been performed.

15. The method of claim 14, wherein the convergence criterion is fulfilled if
RPE2_{current}<RPE2ₜₕ
where RPE2_{current} is the RPE2 of the current iteration, and, RPE2ₜₕ is a predetermined reprojection error.

16. A computer program product stored in a non-transitory computer-readable storage medium that stores computer-executable code for calibrating a stereoscopic camera, the computer-executable process causing a processor of the computer to perform a method comprising:
generating a first plurality of 3D object-point coordinates estimates, E3D, based on at least a plurality of measured 2D image-point correspondences, PCO, of the stereo-image and an initial calibration estimate, CAE, of the stereoscopic camera;
generating a first reprojection error, RPE1, corresponding to the error between the PCO and a projection of the E3D on the CAE;
generating a refined calibration estimate, RCA, of the stereoscopic camera based on at least the PCO, the CAE and the E3D;
generating a second plurality of 3D object-point coordinates estimates, NE3D, based on at least the PCO and the RCA;
generating a second reprojection error, RPE2, corresponding to the error between the PCO and a projection of the NE3D on the RCA; and
updating the RCA of the stereoscopic camera based on at least the PCO, the CAE and the NE3D, wherein whether a convergence criterion has been met is determine based on at least RPE2 by iteratively generating the RCA and the RPE2, the value of RPE2 being indicative of whether or not a camera calibration ground-truth has been found.
